(19) United States
(12) Patent Application Publication
(10) Pub. No.: US 2025/0132609 A1
(43) Pub. Date: Apr. 24, 2025

(54) WIRELESS MUTI-CHARGER SYSTEM FOR GRINDER

(71) Applicant: Shenzhen Cospro Technology USA Inc, City of Industry, CA (US)

(72) Inventor: Feng Wang, Shenzhen (CN)

(21) Appl. No.: 18/510,569

(22) Filed: Nov. 15, 2023

(30) Foreign Application Priority Data
Oct. 18, 2023 (CN) 2023226674664
Oct. 18, 2023 (CN) 2023226723232

(51) Int. Cl. H02J 50/40; H02J 50/00; H02J 50/10; H02J 50/80

(52) U.S. Cl. CPC H02J 50/402; H02J 50/005; H02J 50/10; H02J 50/80

(57) ABSTRACT

A wireless multi-charger system for grinders includes a wireless charger configured to wirelessly communicate with a plurality of grinders; wherein the wireless charger comprises a plurality of transmitting coils configured to wirelessly transmit power to the grinders; and the grinder comprises an actuator, an inner grinding element coupled on the actuator, an outer grinding element spacedly arranged outside the inner grinding element to form a grinding space, and an outermost case rotatably and threadly coupled with the outer grinding element.

### FIELD OF THE DISCLOSURE

The present disclosure relates to a wireless multi-charger system, and more particularly, the wireless multi-charger system having a wireless charger for a plurality of grinders.

### BACKGROUND OF THE DISCLOSURE

Generally, a grinding device may include a rotor part that rotates relative to a stator part, and the distance between the rotor and the stator may be adjusted to change the ground size. Such adjustment of the distance between the rotor and the stator may be implemented using a screw system, or a threaded system. Achieving an appropriate grain size for grinding spices becomes very important, since a properly ground spice has a particular taste and other properties. Therefore, while grinding spices, an appropriately required grain size is kept in mind for obtaining particular properties in the ground spices. In order to change the ground size, the user needs to adjust the screw system or a threaded system located at the bottom portion of the grinding device, and it is more laborious work and is not suitable for elderly or weak persons. Further, the user's hands may be contaminated by the grounded powders.

Conventionally, the grinding device is a rechargeable device with rechargeable batteries that are recharged by a recharging station.

Many types of electrically operated rechargeable device products are known to the prior art. For example, in one earlier invention, a recharging system for the grinding device is disclosed having a recharging base, wherein the recharging base may comprise elastic sheets configured to contact with the rechargeable device in order to provide the power source. However, the elastic sheets exposed outside may be easily to be oxidated and corroded.

All referenced patents, applications and literature are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The disclosed embodiments may seek to satisfy one or more of the above-mentioned desires. Although the present embodiments may obviate one or more of the above-mentioned desires, it should be understood that some aspects of the embodiments might not necessarily obviate them.

### BRIEF SUMMARY OF THE DISCLOSURE

In a general implementation, the wireless multi-charger system for grinders may comprise a wireless charger configured to wirelessly communicate with a plurality of grinders; wherein the wireless charger comprises a plurality of transmitting coils configured to wirelessly transmit power to the grinders; and the grinder comprises an actuator, an inner grinding element coupled on the actuator, an outer grinding element spacedly arranged outside the inner grinding element to form a grinding space, and an outermost case rotatably and threadedly coupled with the outer grinding element.

In another aspect combinable with the general implementation, the grinder comprises a supporting frame where the outer grinding element is coupled with and the supporting frame is operably coupled with the outermost case, wherein the outermost case is exposed outside.

In another aspect combinable with the general implementation, the outermost case is rotated to adjust a space size of the grinding space.

In another aspect combinable with the general implementation, the inner grinding element comprises an inner conic surface and the outer grinding element comprises an outer conic surface, wherein the grinding space is formed between the inner conic surface and the outer conic surface.

In another aspect combinable with the general implementation, the grinder comprises a transmission barrel set in between the outermost case and the outer grinding element and operatively coupled with the outer grinding element.

In another aspect combinable with the general implementation, the grinder comprises a transmission barrel having a ring shape slot rotatably engaged with a protrusion formed on an inner side surface of the outermost case, wherein the outermost case comprises an outer side surface being exposed outside.

In another aspect combinable with the general implementation, the outer grinding element is axially moved relative to an axis of rotation of the outermost case.

In another aspect combinable with the general implementation, the grinder comprises a transmission barrel having a retaining block selectively engaged with one of a plurality of receiving slots formed on an inner side surface of the outermost case.

In another aspect combinable with the general implementation, the grinder comprises a first connection barrel and a second connection barrel spacedly and axially arranged with the first connection barrel, wherein the first connection barrel is rotatably coupled with the outermost case and the second connection barrel is arranged outside the outer grinding element, wherein the inner grinding element is located inside the second connection barrel.

In another aspect combinable with the general implementation, the grinder comprises a connection rod having one end coupled with the actuator and the other end coupled with a spring and a securing cover coupled with one end of the spring, wherein the spring comprises the other end coupled with the inner grinding element.

In another aspect combinable with the general implementation, the wireless charger comprises a main body assembly having a plurality of receiving grooves configured to selectively receive the grinders, wherein one of the transmitting coils is embedded below one of the pluralities of the receiving grooves.

In another aspect combinable with the general implementation, the wireless charger comprises a power transmitter electrically connected to the transmitting coils to receive the power and provide the power to the transmitting coils.

In another aspect combinable with the general implementation, the wireless charger comprises a wireless charger processor and a first memory that stores instructions executed by the wireless charger processor to perform operations comprising: continuously providing power to each of the plurality of transmitting coils one by one; and wirelessly transmitting the power to each of the plurality of grinders one by one by the plurality of transmitting coils.

In another aspect combinable with the general implementation, the wireless charger comprises a switch electrically connected to a wireless charger processor, wherein the switch executes the wireless charger processor to perform operations which stored in a first memory, wherein the operations comprise: wirelessly transmitting power to one of the plurality of grinders with a lower power level comparing with the remaining of the plurality of grinders.

In another aspect combinable with the general implementation, the wireless charger comprises a wireless charger processor and a first memory that stores instructions executed by the wireless charger processor to perform operations comprising wirelessly providing power to one of the plurality of grinders with the power level lower than the threshold value; and continuously and wirelessly transmitting power to another one of the plurality of grinders with a lower power level compared to the remaining of the grinders.

In another aspect combinable with the general implementation, the wireless charger comprises a wireless charger processor and a first memory that stores instructions executed by the wireless charger processor to perform operations comprising wirelessly providing power to one of the plurality of grinders with the power level lower than the threshold value for a predetermined time period; and continuously and wirelessly transmitting power to another one of the plurality of grinders with a lower power level compared to the remaining of the grinders for the same predetermined time period.

In another aspect combinable with the general implementation, the wireless charger comprises a main body assembly comprising a first main case and a second main case spacedly coupled with the first main case to form an installation cavity, wherein the transmitting coils are embedded inside the installation cavity.

In another aspect combinable with the general implementation, the wireless charger comprises a main body assembly comprising a second main case, a third main case spacedly coupled with the second main case to form a storing cavity, and a receiving plate stored in the storing cavity in a drawable configuration.

In another aspect combinable with the general implementation, the wireless charger comprises a main body assembly comprising a first main case, a second main case, a third main case spacedly coupled with the second main case to form a storing cavity, and a connection channel communicated from the first main case to the storing cavity.

In another aspect combinable with the general implementation, the grinder comprises a wireless receiver to electrically communicate with the transmitting coil and configured to receive power from the transmitting coil.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be too precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a perspective view of a wireless multi-charger system for grinders according to an aspect of the embodiments.

FIG. 2 is a block diagram of the wireless multi-charger system for grinders according to an aspect of the embodiments.

FIG. 3 is a cross-sectional view of the grinder for the wireless multi-charger system according to an aspect of the embodiments.

FIG. 4 is a sectional view of the grinder for the wireless multi-charger system according to an aspect of the embodiments.

FIG. 5 is a perspective view of a transmission barrel of the grinder according to an aspect of the embodiments.

FIG. 6 is a perspective view of a main grinder case of the grinder according to an aspect of the embodiments.

FIG. 7 is a perspective view of a supporting frame of the grinder according to an aspect of the embodiments.

FIG. 8 is another perspective view of a supporting frame of the grinder according to an aspect of the embodiments.

FIG. 9 is a perspective view of the wireless charger for the wireless multi-charger system according to an aspect of the embodiments.

FIG. 10 is a cross-sectional view of the wireless charger for the multi-charger system according to an aspect of the embodiments.

FIG. 11 is a perspective view of the wireless charger for the wireless multi-charger system according to an aspect of the embodiments.

FIG. 12 is a block diagram of the wireless charger according to an aspect of the embodiments.

FIG. 13 is a block diagram of the grinder according to an aspect of the embodiments.

FIG. 14 is a block diagram showing a charging analysis performed by the wireless charger according to an aspect of the embodiments.

FIG. 15 is another block diagram showing the charging analysis performed by the wireless charger according to an aspect of the embodiments.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112 (f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

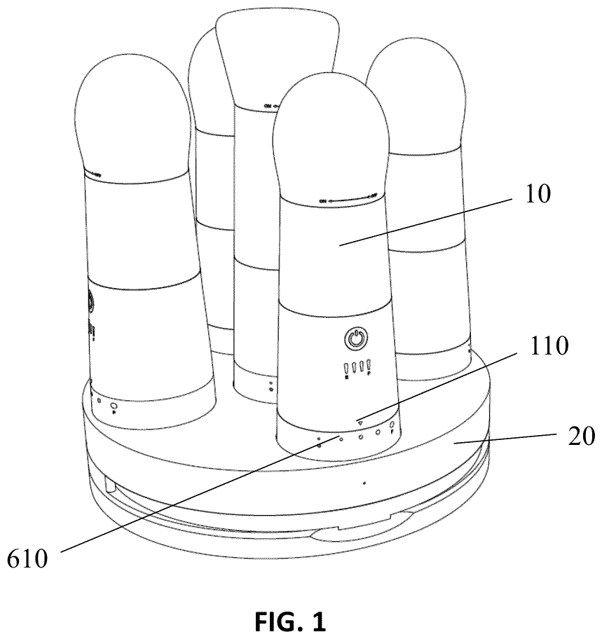

FIGS. 1 to 4 generally depict a wireless multi-charger system for grinders according to an aspect of the embodiment.

Referring to FIGS. 1 to 4, the wireless multi-charger system may comprise a wireless charger 20 and a plurality of grinders 10, wherein the grinder may comprise a main grinder case 100, an actuator 200, an inner grinding element 300, an outer grinding element 400, a supporting frame 500, and an outermost case 600, wherein the actuator 200 may be installed inside the main grinder case 100, and the inner grinding element 300 may be rotatably coupled to the actuator 200, wherein the outer grinding element 400 may be spacedly arranged outside the inner grinding element 300 to form a grinding space 1300. In some embodiments, the supporting frame 500 may be operatively coupled with the main grinder case 100 and the outer grinding element 400 may be movably installed on the supporting frame 500, wherein the outer grinding element 400 may be installed on the supporting frame 500, wherein the outermost case 600 may be operatively installed on the supporting frame 500. In still some embodiments, the outermost case 600 may be rotatably and threadedly coupled with the outer grinding element 400, and the outermost case 600 may be exposed outside. In this situation, the outermost case 600 may be rotatably and threadedly coupled with the supporting frame 500, and for example, the outermost case 600 may be rotated to drive the outer grinding element 400 (installed on the supporting frame 500) to perform an axial movement (move up and down), and in such a way, the outer grinding element 400 may be axially moved relative to an axis of rotation of the outermost case 600. In such a way, the outermost case 600 may be rotated to adjust a space size of the grinding space 1300.

In still some embodiments, the actuator 200 may be activated to drive a rotation motion of the inner grinding element 300, and while the inner grinding element 300 is rotated relative to the outer grinding element 400, seasoning powers placed inside the grinding space 1300 may be squeezed and grounded by the inner grinding element 300 and the outer grinding element 400. Since the space size of the grinding space 1300 may be adjusted by a rotation of the outermost case 600, the particle sizes of the seasoning powers may be determined by the space size of the grinding space 1300.

In still some embodiments, the outer grinding element 400 may be arranged on the supporting frame 500 and the outermost case 600 may be movably installed on the supporting frame 500, and in such a way, while the outermost case 600 is rotated, the outer grinding element 40 may be driven by the supporting frame 500 and be axially moved up and down to adjust the space size of the grinding space 1300.

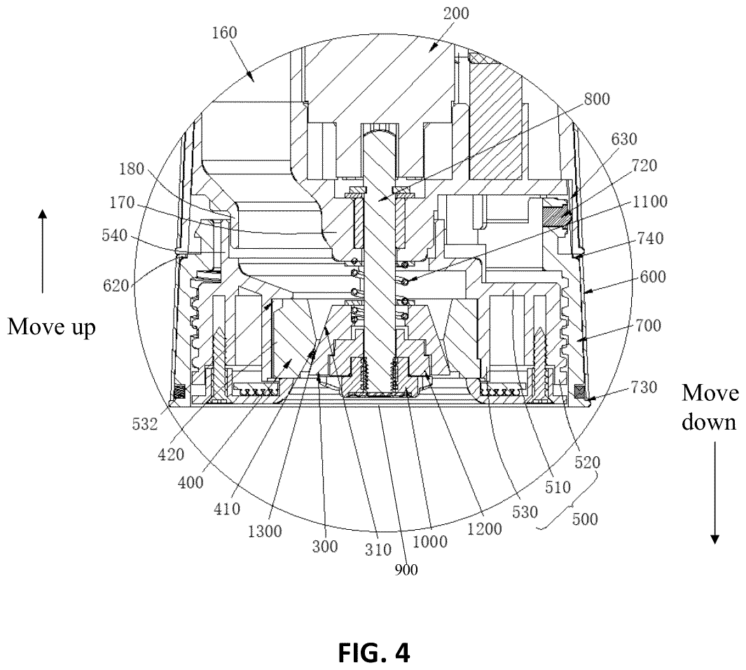

As shown further detail in FIG. 4, the inner grinding element 300 may comprise an inner conic surface 310 and the outer grinding element 400 may comprise an outer conic surface 410, wherein the inner conic surface 310 and the outer conic surface 410 may be both circular conical surface, wherein the grinding space 1300 may be formed between the inner conic surface 310 and the outer conic surface 410, wherein the space size of the grinding surface 1300 may be gradually increased, and in such a way, while the outer grinding element 400 is upwardly moved (along a connection rod 800), the space size of the grinding space 1300 may be gradually increased; in other words, while the outer grinding element 400 is downwardly moved (along a connection rod 800), the space size of the grinding space 1300 may be gradually decreased. The inner conic surface 310 may comprise a first cone angle which is smaller than a second cone angle of the outer conic surface 410, and in such a way, while the outer grinding element 400 is upwardly moved (along a connection rod 800), the space size of the grinding space 1300 may be gradually increased.

As shown in further details in FIG. 1, the main grinder case 100 may comprise a direction mark 110 and the outermost case 600 may comprise a plurality of level marks 610 surrounding around the outermost case 600; while the outermost case 600 is rotated with that one of the plurality of level marks 610 is aligned with the direction mark 110, different space size of the grinding space 1300 may be defined.

In some embodiments, each of the level marks 610 may be relative to each of the space size of the grinding space 1300, wherein the level marks 610 may be arranged at an outer surface of the outermost case 600, and while the direction mark 110 is aligned with one of the level marks 610, the corresponding space size of the grinding space 1300 may be determined by each of the level marks 610.

In still some embodiments, the user may be selectively aligning the direction mark 110 to one of the level marks 610, so as to select the corresponding space size of the grinding space 1300 by the alignment between the direction mark 110 and the level mark 610.

In still some embodiments, each of the level marks 610 may be spacedly arranged with each other, wherein sizes of each of the level marks 610 is gradually increased, and in such a way, a larger size of the level mark 610 may be relative to a larger size of the space size of the grinding space 1300; in other words, a smaller size of the level mark 610 may be relative to a smaller size of the space size of the grinding space 1300.

Alternatively, the level marks 610 may be protruded or indented, or line shapes. In other words, the level marks 610 may comprise identification lights.

Alternatively, the direction mark 110 may be protruded, indented, or line-shaped.

Continuing to FIG. 1, the outermost case 610 may comprise five level marks 610, and each of the level marks 610 may be a circle, wherein each of the level marks 610 may be relative to the corresponding space size of the grinding space 1300, wherein sizes of each of the level marks 610 may be gradually increased.

Referring to FIG. 4, the grinder may comprise a transmission barrel 700 set between the outermost case 600 and the supporting frame 500, wherein the transmission barrel 700 may be operatively coupled with the outermost case 600. It should be noted that the transmission barrel 700 may be threadedly coupled with the supporting frame 500.

In some embodiments, while the outermost case 600 is rotated, the transmission barrel 700 is driven to be rotated, and at the same time, the supporting frame 500 may be driven to be axially moved due to the threaded connection between the transmission barrel 700 and the supporting frame 500, and in such a way, the outer grinding element 400 may be driven to perform the axial motion with the supporting frame 500 being coupled with the outer grinding element 400.

In still some embodiments, according to the above embodiments, there is no threaded configuration arranged on the outermost case 600, and in such a way, the outermost case 600 may be thin enough to improve the aesthetic effects.

Referring to FIG. 4 to FIG. 6, the outer surface of the transmission barrel 700 may comprise a ring shape slot 710 rotatably engaged with a protrusion 120 formed on an inner side surface of the outermost case 600, wherein the outermost case 600 comprises an outer side surface being exposed outside, and in such a way, the protrusion 120 may be selectively locked on different positions of the ring shape slot 710. For example, in some embodiments, the protrusion 120 may be slid along the ring shape slot 710 and selectively locked on the different positions of the ring shape slot 710.

As shown in further details in FIG. 4 to FIG. 6, the transmission barrel 700 may have a retaining block 720 selectively engaged with one of a plurality of receiving slots 130 formed on an inner side surface of the outermost case 600, wherein each of the plurality of the receiving slots 130 may be spacedly arranged and surrounding around the inner side surface of the outermost case 600. In some embodiments, each of the receiving slots 130 is aligned with each of the corresponding level marks 610, and in this situation, while the transmission barrel 700 is rotated, the retaining block 720 may be driven to be locked into one of the receiving slots 130.

In still some embodiments, the transmission barrel 700 may comprise an installation hole 760, wherein the retaining block 720 may be inserted inside the installation hole 760. It should be noted that the retaining block 720 may be a flexible material, and in such a way, the retaining block 720 may be squeezed to be inserted into the installation hole 760 and be reinstated to its original form after being inserted into the installation hole 760.

In still some embodiments, a bottom portion of the retaining block 720 may be an arc shape, wherein the size of the receiving slot 130 may be gradually increased from a bottom portion of the main grinder case 100 to a top portion of the main grinder case 100, wherein the receiving slot 130 may be an arc shape, and in such a way, the retaining block 720 may be upwardly slid along the receiving slot 130 towards the top portion of the main grinder case 100, and further be squeezed to be inserted into the installation hole 760.

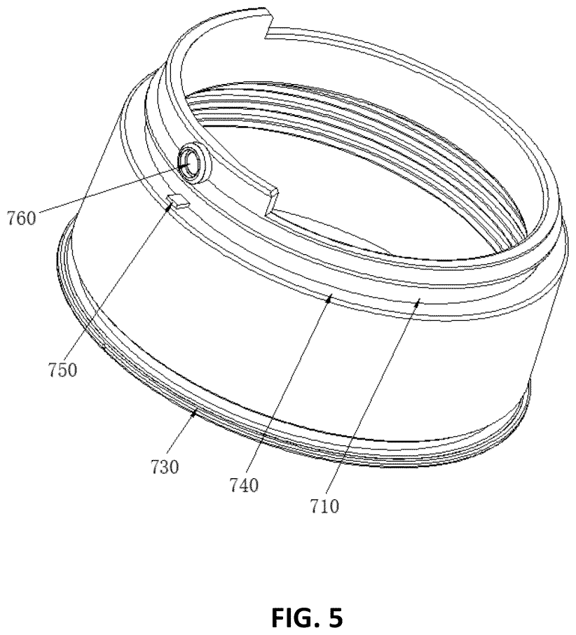

Referring to FIG. 4 and FIG. 5, the transmission barrel 700 may comprise a first platform 730 formed on a top portion of the transmission barrel 700 and a second platform formed 740 on a bottom portion of the transmission barrel 700. In some embodiments, the outermost case 600 may comprise an indented edge 620 formed on a top end of the outermost case 600 and a bottom end opposite of the top end of the outermost case 600, wherein the bottom end of the outermost case 600 may be coupled with the second platform 740 of the transmission barrel 700 and the indented edge 620 may be coupled with the first platform 730 of the transmission barrel 700.

In some embodiments, the second platform 740 may comprise a position block 750 and the indented edge 620 may comprise a position groove 630, wherein the position block 750 may be engaged with the position groove 630, and in such a way, the transmission barrel 700 may be synchronously rotated with respect to the outermost case 600.

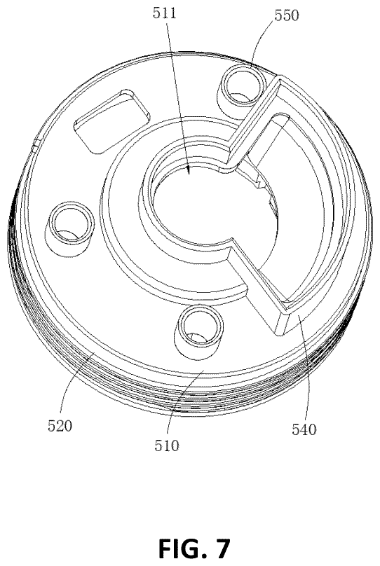

Referring to FIGS. 4 and 7, the supporting frame 500 may comprise a top plate 510, a first connection barrel 520, and a second connection barrel 530 spacedly and axially arranged with the first connection barrel 520, wherein the first connection barrel 520 is rotatably coupled with the outermost case 600 (operatively/movably coupled with the transmission barrel 700) and the second connection barrel 530 is arranged outside the outer grinding element 400, wherein the inner grinding element 300 is located inside the second connection barrel 530. In still some embodiments, the supporting frame 500 may comprise a connection hole 511 arranged adjacent to or on the top plate 510, wherein the grinder may comprise a connection rod 800 having one end coupled with the actuator 200, wherein the connection rod 800 is embedded inside the second connection barrel 530 and coupled with the inner grinding element 300, wherein the connection hole 511 is communicated with the second connection barrel 530, and in such a way, the seasoning particles may be entered into the second connection barrel 530 through the connection hole 511, and further passed into the grinding space 1300 formed between the inner grinding element 300 and the outer grinding element 400.

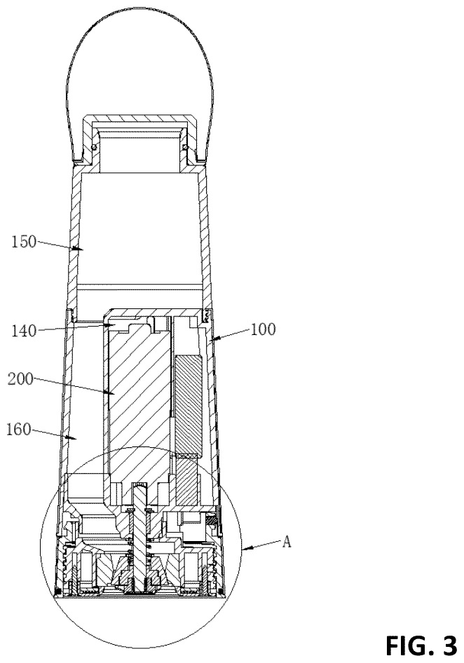

Referring to FIGS. 3, 4, and 6, the main grinder case 100 may comprise a driving reservoir 140, a storing reservoir 150 arranged above the driving reservoir 140, and a transmitting channel 160 communicated with the storing reservoir 150, wherein the transmitting channel 160 may be communicated with the second connection barrel 530, and at this situation, the seasoning particles stored inside the storing reservoir 150 may be entered into the second connection barrel 530 through the transmitting channel 160.

Referring to FIGS. 3 and 4, the main grinder case 100 may comprise a first connection wall 170 integrally extended from the driving reservoir 140, a second connection wall 180 integrally extended from the transmitting channel 160, and a third connection wall 540 integrally extended from the top plate 510, wherein the first connection wall 170 is coupled with the second connection wall 180, and the third connection wall 540 may be movably coupled with the first connection wall 170 and the second connection wall 180, and in such a way, the driving reservoir 140 may be extended to the second connection barrel 530 and the transmitting channel 160 is communicated with the second connection barrel 530.

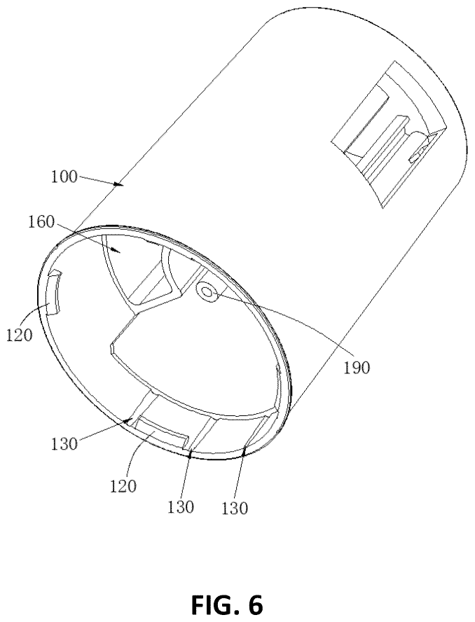

Referring to FIG. 6 and FIG. 7, the main grinder case 100 may comprise a first guiding column 190 integrally extended from the top portion of the main grinder case 100 and a second guiding column 550 integrally extended from the top plate 510, wherein the first guiding column 190 may be engaged with the second guiding column 550, so as to secure the main grinder case 100 with the supporting frame 500.

Referring to FIG. 4, the grinder may further comprise a bottom cover 900 tightly coupled with the supporting frame 500, wherein the outer grinding element 400 may be tightly coupled with the supporting frame 500 and the bottom cover 900.

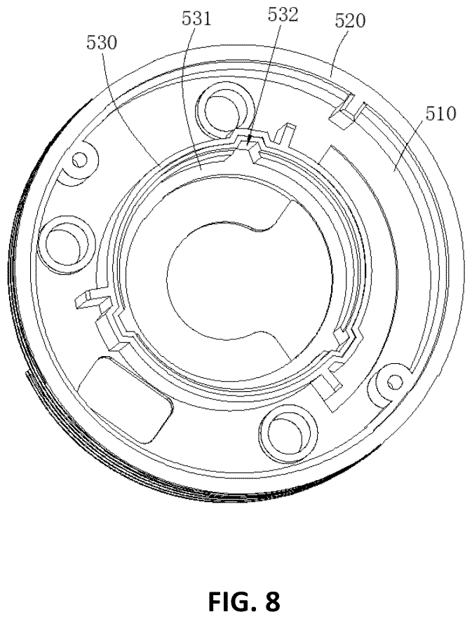

Referring to FIG. 4 and FIG. 8, the second connection barrel 530 may comprise a third platform 531 formed at an inner surface of the second connection barrel 530, wherein the outer grinding element 400 may be sandwichedly arranged between the third platform 531 and the bottom cover 900.

Referring to FIG. 4 and FIG. 8, the outer grinding element 400 may comprise a retaining protrusion 420 arranged on an outer surface of the outer grinding element 400 and the second connection barrel 530 may comprise a locking slot 532, wherein the retaining protrusion 420 may be inserted into the locking slot 532 to affix the outer grinding element 400 with the second connection barrel 530.

In some embodiments, the outer grinding element 400 may be affixed on the supporting frame 500 by the bottom cover 900.

It should be understood that the above-described method for affixing the outer grinding element 400 with the supporting frame 500 is exemplary and any other methods can be adopted in various embodiments of this disclosure.

In still some embodiments, the bottom cover 900 may be screwed on the supporting frame 500.

In still some embodiments, referring to FIG. 4, the connection rod 800 may comprise the other end which is opposite of the one end coupled with the actuator 200, wherein the other end of the connection rod 800 may be coupled with a spring 1100 and a securing cover 1000 coupled with one end of the spring, wherein the spring 1100 comprises the other end coupled with the inner grinding element 300, and in such a manner, the securing cover 1000 may be rotated to adjust the space size of the grinding space 1300, in order to maintain the space size of the grinding space 1300 in an appropriate value.

In still some embodiments, as shown in FIG. 4, the main grinder case 100 may comprise a connection element 1200 coupled between the inner grinding element 300 and the securing cover 1000.

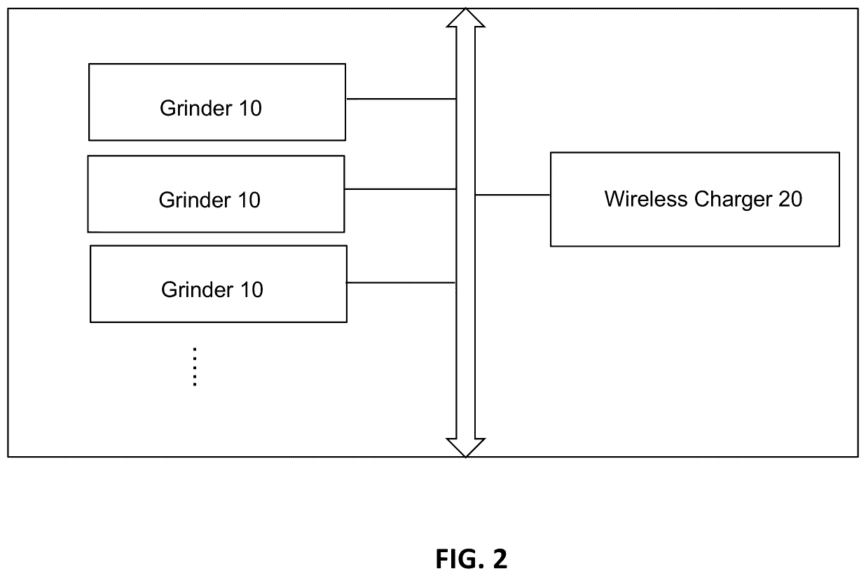

Referring back to FIG. 2 of the drawings, the wireless multi-charger system may comprise a wireless charger 20 and a plurality of grinders 10, wherein the grinders 10 may be configured for grinding seasoning particles into smaller seasoning powders.

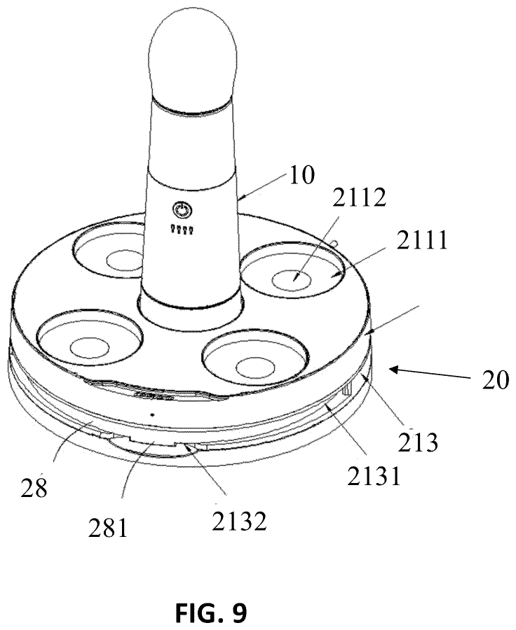

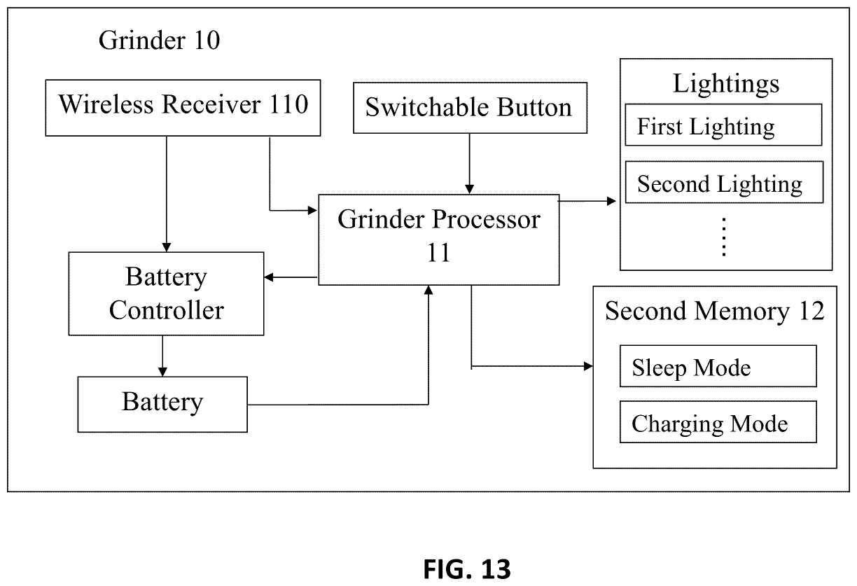

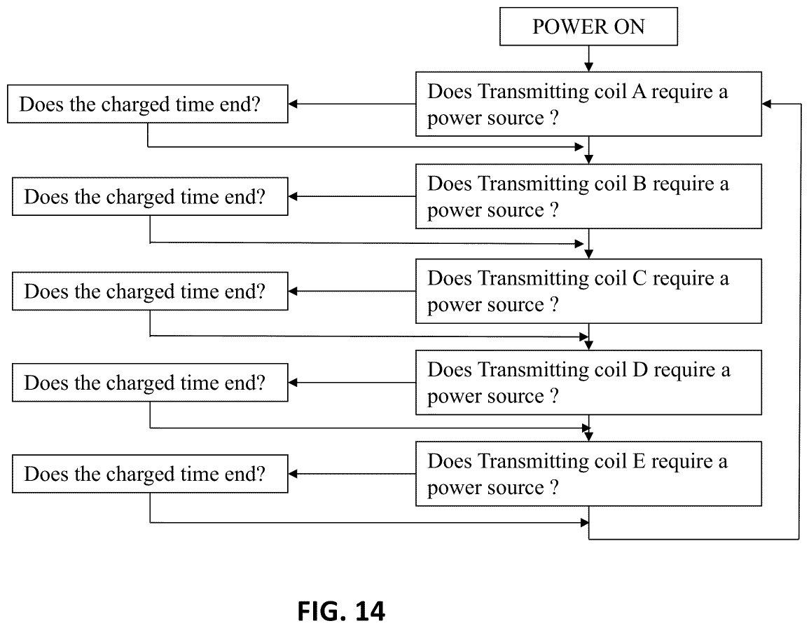

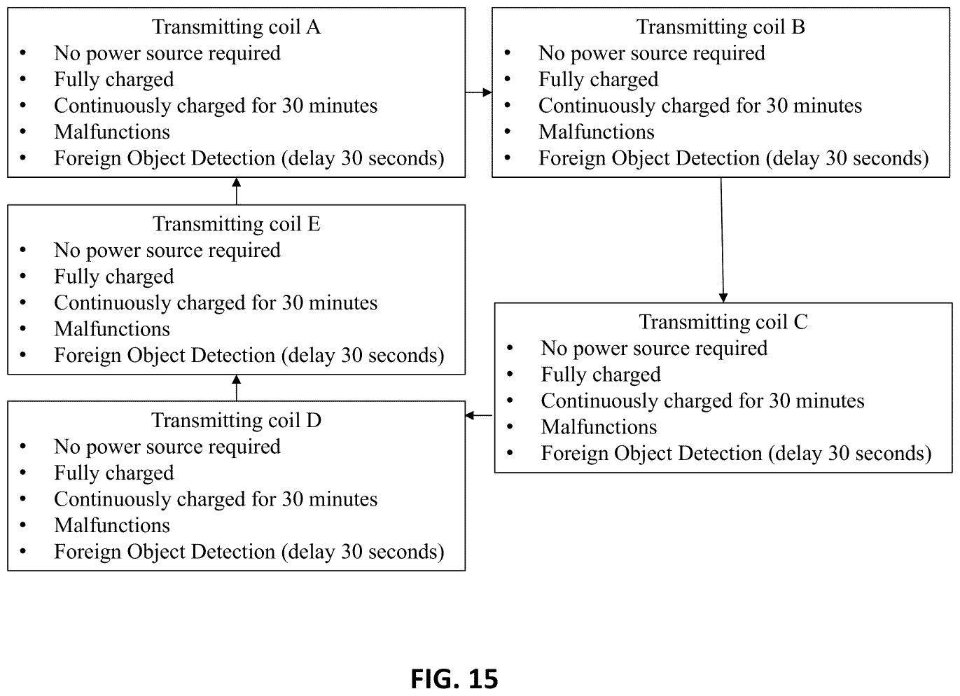

Referring to FIGS. 9-15 of the drawings, the wireless charger 20 may be configured to wirelessly communicate with the plurality of grinders 10, wherein the wireless charger 20 may comprise a main body assembly 21 having a plurality of receiving grooves 2111 configured to selectively receive the grinders 10, wherein the wireless charger 20 may comprise a power transmitter 23 having a plurality of transmitting coils, including a transmitting coil A (231), a transmitting coil B (232), a transmitting coil C (233), a transmitting coil D (234), and a transmitting coil E (235), configured to wirelessly transmit power to the grinders 10 and a power adaptor 22 connected to an outside power source which is configured to provide power, wherein the power adaptor 22 may be electrically connected to the power transmitter 23 to provide electricity power to the power transmitter 23. In some embodiments, the grinder 10 may comprise a wireless receiver 110 wirelessly and electrically connected with each of the transmitting coils of the power transmitter 23, and in such a way, the wireless receiver 110 of grinder 10 may receive the electricity power provided by the transmitting coils of the power transmitter 23. In still some embodiments, the power transmitter 23 and the power adaptor 22 may be embedded inside the main body assembly 21. In still some embodiments, one of the transmitting coils (the transmitting coil A (231), or the transmitting coil B (232), or the transmitting coil C (233), or the transmitting coil D (234), or the transmitting coil E (235)) may be embedded below one of the pluralities of the receiving grooves 2111. In some embodiments, each one of the transmitting coils (the transmitting coil A (231), or the transmitting coil B (232), or the transmitting coil C (233), or the transmitting coil D (234), or the transmitting coil E (235)) may be embedded below each one of the pluralities of the receiving grooves 2111.

In some embodiments, one of the transmitting coils (the transmitting coil A (231), or the transmitting coil B (232), or the transmitting coil C (233), or the transmitting coil D (234), or the transmitting coil E (235)) may be arranged to a position relative to the wireless receiver 100 of the grinder 10, wherein after the power adapter 22 provides the power to the transmitting coil (the transmitting coil A (231), or/and the transmitting coil B (232), or/and the transmitting coil C (233), or/and the transmitting coil D (234), or/and the transmitting coil E (235)), the transmitting coil (the transmitting coil A (231), or/and the transmitting coil B (232), or/and the transmitting coil C (233), or/and the transmitting coil D (234), or/and the transmitting coil E (235)) may emit electromagnetic radiation to be received by the wireless receiver 110 of the grinder 10, so as to activate operations of the grinder 10.

In still some embodiments, the grinder 10 may be inserted inside the receiving grooves 2111, wherein each of the transmitting coils, including a transmitting coil A (231), a transmitting coil B (232), a transmitting coil C (233), a transmitting coil D (234), a transmitting coil E (235), may be embedded below each of the receiving grooves 2111, and each of the transmitting coils including a transmitting coil A (231), a transmitting coil B (232), a transmitting coil C (233), a transmitting coil D (234), and a transmitting coil E (235), may be embedded inside the main body assembly 21, and in such a way, the transmitting coils may be protected inside the main body assembly 21.

In still some embodiments, each of the plurality of the grinders 10 may be inserted inside each of the receiving grooves 2111, and at such situation, each of the transmitting coils, including a transmitting coil A (231), a transmitting coil B (232), a transmitting coil C (233), a transmitting coil D (234), a transmitting coil E (235), may wirelessly provide the electricity power to each of wireless receiver 100 of each of the plurality of the grinders 10; in other words, the wireless charger 20 may provide electricity power to the plurality of grinders 10.

In some embodiments, the power transmitter 23, including a transmitting coil A (231), a transmitting coil B (232), a transmitting coil C (233), a transmitting coil D (234), and a transmitting coil E (235), and the wireless receiver 110 may be both ring shape.

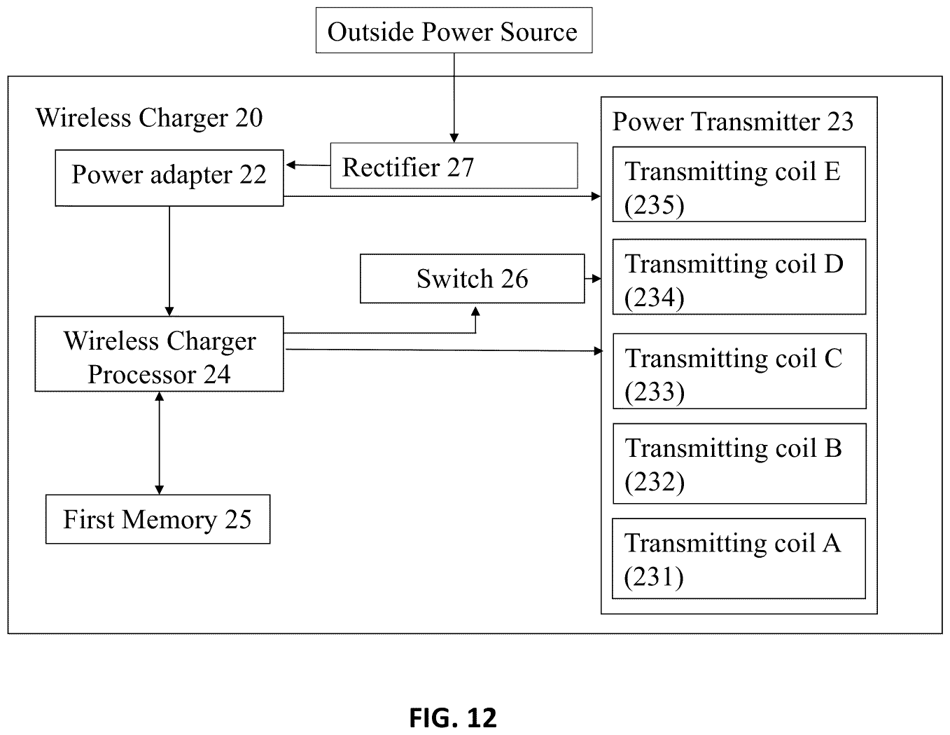

Referring to FIG. 12 of the drawings, the wireless charger 20 may comprise a wireless charger processor 24 and a first memory 25 that stores instructions executed by the wireless charger processor 24 to perform operations comprising: wirelessly and continuously providing electricity power to each of the plurality of transmitting coils, including a transmitting coil A (231), a transmitting coil B (232), a transmitting coil C (233), a transmitting coil D (234), and a transmitting coil E (235), one by one; and wirelessly transmitting the electricity power to each of the wireless receiver 100 of each of the plurality of grinders 10 one by one by the plurality of transmitting coils, including a transmitting coil A (231), a transmitting coil B (232), a transmitting coil C (233), a transmitting coil D (234), and a transmitting coil E (235). In still some embodiments, the wireless charger processor 24 may be electrically connected to the power adaptor 22 and each of the plurality of transmitting coils, including a transmitting coil A (231), a transmitting coil B (232), a transmitting coil C (233), a transmitting coil D (234), and a transmitting coil E (235).

In some embodiments, the wireless charger 20 may comprise a switch 26 electrically connected to the wireless charger processor 24, wherein the switch 26 executes the wireless charger processor 24 to perform operations stored in the first memory 25, wherein the operations comprise: wirelessly transmitting power to one of the plurality of grinders 10 with a lower power level comparing with the remaining of the plurality of grinders 10.

In still some embodiments, the wireless charger 20 may comprise the wireless charger processor 24 and the first memory 25 that stores instructions executed by the wireless charger processor 24 to perform operations comprising wirelessly providing power to the wireless receiver 110 of one of the plurality of grinders 10 with the power level lower than the threshold value; and wirelessly and continuously transmitting power to the wireless receiver 110 of another one of the plurality of grinders 10 with a lower power level compared to the remaining of the grinders 10. In addition, while one of the pluralities of the grinders is fully charged, the wireless receiver 110 stops operations without receiving any electricity power.

In still some embodiments, the wireless charger 20 may comprise the wireless charger processor 24 and the first memory 25 that stores instructions executed by the wireless charger processor 24 to perform operations comprising wirelessly providing electricity power to the wireless receiver 110 of one of the plurality of grinders 10 with the power level lower than the threshold value for a predetermined time period, for example, 30 minutes; and wirelessly and continuously transmitting electricity power to the wireless receiver 110 of another one of the plurality of grinders 10 with a lower power level compared to the remaining of the grinders for the same predetermined time period, for example, 30 minutes.

Referring to FIG. 12 of the drawings, the wireless charger 20 may comprise a rectifier 27 electrically connected to the power adaptor 22 and the outside power source, wherein the rectifier 27 may be configured to convert alternating current provided by the outside power source into direct current by allowing a current to flow through the wireless charger 20 in one direction only. It should be noted that the wireless charger 20 may comprise without the rectifier 27.

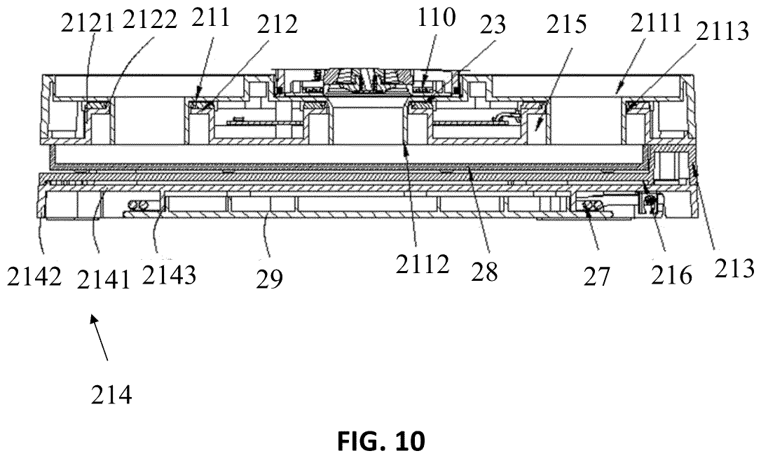

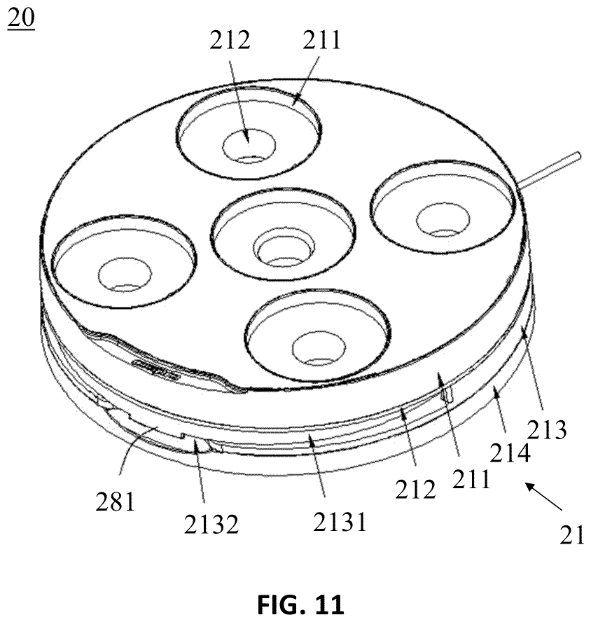

Referring to FIGS. 10 and 11, the main body assembly 21 may comprise a first main case 211 and a second main case 212 spacedly coupled with the first main case 211 to form an installation cavity 215, wherein the transmitting coils, including a transmitting coil A (231), a transmitting coil B (232), a transmitting coil C (233), a transmitting coil D (234), and a transmitting coil E (235), may be embedded inside the installation cavity 215. In some embodiments, the main body assembly 21 may further comprise a supporting platform 2121 arranged between the first main case 211 and the second main base 212, wherein the transmitting coils, including a transmitting coil A (231), a transmitting coil B (232), a transmitting coil C (233), a transmitting coil D (234), and a transmitting coil E (235), may be arranged on the supporting platform 2121, and in such a way, the transmitting coils, including a transmitting coil A (231), a transmitting coil B (232), a transmitting coil C (233), a transmitting coil D (234), and a transmitting coil E (235) may be arranged close to the wireless receiver 110 of the grinder 10 to facilitate the wireless charging between the wireless charger 20 and the grinder 10.

As shown in further detail in FIG. 10, the second main case 212 may comprise a retaining cylinder 2122 aligned with the supporting platform 2121, wherein the retaining cylinder 2122 may be coupled with the supporting platform 2121 to form the installation cavity 215, and in such a manner, the power transmitter 23 having the transmitting coils, including a transmitting coil A (231), a transmitting coil B (232), a transmitting coil C (233), a transmitting coil D (234), and a transmitting coil E (235) may be secured inside the installation cavity 215.

Continuing to FIG. 10, the main body assembly 21 may comprise a second main case 212, a third main case 213 spacedly coupled with the second main case 212 to form a storing cavity 216, and a receiving plate 28 stored in the storing cavity 216 in a drawable configuration, and in such a way, the receiving plate 28 may be drawn out and be cleaned.

Referring to FIG. 10 and FIG. 11, the main body assembly 21 may comprise the first main case 211, the second main case 212, the third main case 213 spacedly coupled with the second main case to form the storing cavity 216, and a connection channel 2112 communicated from the first main case 211 to the storing cavity 216, wherein the remaining seasoning powders may be passed through the connection channel 2112 and entered into the receiving plate 28 placed inside the storing cavity 216. It should be noted that, in some embodiments, the connection channel 2112 is formed on the receiving groove 2111, and while the grinder 10 is placed on the receiving groove 2111 to perform the grinding operation, the remaining seasoning powders may be naturally passed through the connection channel 2112 and entered into the receiving plate 28.

Continuing to FIG. 11, the third main case 213 may comprise an insertable entrance 2131 formed on an outer side of the third main case 213, wherein the receiving plate 28 may be inserted into the storing cavity 216 through the insertable entrance 2131.

Continuing to FIG. 11, the receiving plate 28 may comprise a handle 281 formed on the periphery of the receiving plate 28, and the third main case 213 may further comprise a plate entrance 2132 having a size larger than the size of the handle 281, wherein the user may use the finger to take out the receiving plate 28 through the plate entrance 2132.

Referring to FIG. 10 and FIG. 11, the main body assembly 21 may further comprise a fourth main case 214 arranged below the third main case 113, wherein the fourth main case 214 may further comprise a top fourth wall 2141 integrally extended from the third main case 213 and a side fourth wall 2142 downwardly and integrally extended from the top fourth wall 2141, wherein a cavity is formed by the top fourth wall 2141, and the side fourth wall 2142, and rectifier 27 may be placed inside the cavity.

Referring to FIG. 10 and FIG. 11, the fourth main case 214 may further comprise a surrounding fourth wall 2143, wherein wires of the rectifier 27 may be surrounded on the surrounding fourth wall 2143, and the main body assembly 21 may further comprise a block wall 29 arranged below the surrounding fourth wall 2143 to protect the wires of the rectifier 27.

Referring to FIGS. 12-15, the grinder 10 may comprise the grinder processor 11 and a second memory first memory 12 that stores instructions executed by the grinder processor 11 to perform operations comprising, in a sleep mode, shutting down the one of the plurality of grinders while the grinder is fully charged.

Referring to FIGS. 11-14, the grinder 10 may comprise the grinder processor 11 and the second memory first memory 12 that stores instructions executed by the grinder processor 11 to perform operations comprising, in a charging mode, wirelessly receiving electricity power by the wireless receiver 110 of one of the plurality of grinders 10 with the power level lower than the threshold value.

In some embodiments, the wireless charger 20 may comprise the wireless charger processor 24 and the first memory 25 that stores instructions executed by the wireless charger processor 24 to perform operations comprising performing a charging analysis on each of the grinders 10 one by one, wherein the charging analysis may comprise determining whether a charged time ends for each of the grinders 10; and determining whether each of the transmitting coils (including a transmitting coil A (231), a transmitting coil B (232), a transmitting coil C (233), a transmitting coil D (234), and a transmitting coil E (235)) requires the electricity power.

In still some embodiments, the charging analysis may further comprise: performing a malfunction analysis based on an operational state of the grinder; and stopping providing electricity power to the grinder while the grinder is malfunctioning.

In still some embodiments, the charging analysis may further comprise: performing a foreign objection detection and stopping providing power to the transmitting coil while an unmatched device is detected.

In still some embodiments, the charging analysis may further comprise: in a sleep mode, receiving a fully charged signal from one of the plurality of grinders; and stopping providing power to the corresponding transmitting coils (no power source required), which is wirelessly communicated with the wireless receiver 110 of the grinder 10.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more or different elements, which are disclosed herein even when not initially claimed in such combinations.

Thus, specific embodiments and applications of a wireless multi-charger system for grinders have been disclosed. It should be apparent, however, to those skilled in the art that many more modifications besides those already described are possible without departing from the disclosed concepts herein. The disclosed embodiments, therefore, are not to be remaining restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. A wireless multi-charger system for grinders, comprising,
a wireless charger configured to wirelessly and electrically communicate with a plurality of grinders; wherein
the wireless charger comprises a plurality of transmitting coils configured to wirelessly transmit power to the grinders; and
the grinder comprises an actuator, an inner grinding element coupled on the actuator, an outer grinding element spacedly arranged outside the inner grinding element to form a grinding space, and an outermost case rotatably and threadedly coupled with the outer grinding element.

2. The wireless multi-charger system of claim 1, wherein the grinder comprises a supporting frame where the outer grinding element is coupled with and the supporting frame is operably coupled with the outermost case, wherein the outermost case is exposed outside.

3. The wireless multi-charger system of claim 1, wherein the outermost case is rotated to adjust a space size of the grinding space.

4. The wireless multi-charger system of claim 1, wherein the inner grinding element comprises an inner conic surface and the outer grinding element comprises an outer conic surface, wherein the grinding space is formed between the inner conic surface and the outer conic surface.

5. The wireless multi-charger system of claim 1, wherein the grinder comprises a transmission barrel set in between the outermost case and the outer grinding element and movably coupled with the outer grinding element.

6. The wireless multi-charger system of claim 1, wherein the grinder comprises a transmission barrel having a ring shape slot rotatably engaged with a protrusion formed on an inner side surface of the outermost case, wherein the outermost case comprises an outer side surface being exposed outside.

7. The wireless multi-charger system of claim 1, wherein the outer grinding element is axially moved relative to an axis of rotation of the outermost case.

8. The wireless multi-charger system of claim 1, wherein the grinder comprises a transmission barrel having a retaining block selectively engaged with one of a plurality of receiving slots formed on an inner side surface of the outermost case.

9. The wireless multi-charger system of claim 1, wherein the grinder comprises a first connection barrel and a second connection barrel spacedly and axially arranged with the first connection barrel, wherein the first connection barrel is rotatably coupled with the outermost case and the second connection barrel is arranged outside the outer grinding element, wherein the inner grinding element is located inside the second connection barrel.

10. The wireless multi-charger system of claim 1, wherein the grinder comprises a connection rod having one end coupled with the actuator and the other end coupled with a spring and a securing cover coupled with one end of the spring, wherein the spring comprises the other end coupled with the inner grinding element.

11. The wireless multi-charger system of claim 1, wherein the wireless charger comprises a main body assembly having a plurality of receiving grooves configured to selectively receive the grinders, wherein each one of the transmitting coils is embedded below each one of the pluralities of the receiving grooves.

12. The wireless multi-charger system of claim 1, wherein the wireless charger comprises a power transmitter electrically connected to the transmitting coils to receive the power from an outside power source and provide the power to the transmitting coils.

13. The wireless multi-charger system of claim 1, wherein the wireless charger comprises a wireless charger processor and a first memory that stores instructions executed by the wireless charger processor to perform operations comprising: continuously and wirelessly providing power to each of the plurality of transmitting coils one by one; and wirelessly transmitting the power to each of the plurality of grinders one by one by the plurality of transmitting coils.

14. The wireless multi-charger system of claim 1, wherein the wireless charger comprises a switch electrically connected to a wireless charger processor, wherein the switch executes the wireless charger processor to perform operations which stored in a first memory, wherein the operations comprises: wirelessly transmitting power to one of the plurality of grinders with a lower power level comparing with the remaining of the plurality of grinders.

15. The wireless multi-charger system of claim 1, wherein the wireless charger comprises a wireless charger processor and a first memory that stores instructions executed by the wireless charger processor to perform operations comprising wirelessly providing power to one of the plurality of grinder with a power level lower than a threshold value; and continuously and wirelessly transmitting power to another one of the plurality of grinders with a lower power level compared to the remaining of the grinders.

16. The wireless multi-charger system of claim 1, wherein the wireless charger comprises a wireless charger processor and a first memory that stores instructions executed by the wireless charger processor to perform operations comprising wirelessly providing the power to one of the plurality of grinders with a power level lower than a threshold value for a predetermined time period; and continuously and wirelessly transmitting the power to another one of the plurality of grinders with a lower power level compared to the remaining of the grinders for the same predetermined time period.

17. The wireless multi-charger system of claim 1, wherein the wireless charger comprises a main body assembly comprising a first main case and a second main case spacedly coupled with the first main case to form an installation cavity, wherein the transmitting coils are embedded inside the installation cavity.

18. The wireless multi-charger system of claim 1, wherein the wireless charger comprises a main body assembly comprising a second main case, a third main case spacedly coupled with the second main case to form a storing cavity, and a receiving plate stored in the storing cavity in a drawable configuration.

19. The wireless multi-charger system of claim 1, wherein the wireless charger comprises a main body assembly comprising a first main case, a second main case, a third main case spacedly coupled with the second main case to form a storing cavity, and a connection channel communicated from the first main case to the storing cavity.

20. The wireless multi-charger system of claim 1, wherein the grinder comprises a wireless receiver electrically communicates with the transmitting coil and configured to receive the power from the transmitting coil.
